(19) United States
(12) Patent Application Publication
(10) Pub. No.: US 2007/0101157 A1
(43) Pub. Date: May 3, 2007

(54) Security in digital data distribution

(75) Inventor: Richard Faria, Herts (GB)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Cerberus Central Limited, London (GB)

(21) Appl. No.: 10/507,830

(22) PCT Filed: Mar. 14, 2003
(86) PCT No.: PCT/GB03/01085

§ 371 Date: Dec. 22, 2006

(30) Foreign Application Priority Data
Mar. 14, 2002 (GB) 0206034.1
May 15, 2002 (GB) 0211134.2

(51) Int. Cl. G06F 12/14

(52) U.S. Cl. 713/193

(57) ABSTRACT

A method of recording digital content data onto an AVDDM (Audio Visual Data Distributable Medium) (32) such as a compact disc. The method comprises: assigning (314) a unique identifier (36) to the AVDDM (32); using the unique identifier (36) to create (318) a plurality of data errors in and/or format variations of the digital content data (22) unique to that AVDDM; and recording (328, 330) the digital content data incorporating the data errors and/or format variations onto the AVDDM (32). The data errors and/or format variations are stored in a copyright protection map (44) which is unique for every AVDDM (32). An AVDDM produced by this method is read by combining the unique copyright protection map (44) with the copyright protected data to form the original digital data content.

### TECHNICAL FIELD

The present invention concerns improvements relating to security in digital data distribution of, for example, audio data on Compact Discs (CDs). The present invention relates particularly, although not exclusively, to improving the security in the distribution of dynamically copyrighted audio data to handheld devices such as mobile phones. The present invention may be employed as part of a data composing apparatus in which audio data, for example, can be selected by a paying consumer and retrieved from a database of stored audio data.

### BACKGROUND ART

Copyright protection is a growing problem for all copyright based industries, including the music industry, the film/video industry, the computer games industry, the computer software industry, or any other industry where a product can be digitised. The basis of the problem is that a single product (known as a master) is created and, in some circumstances, it is copyright protected and then mass-produced. Any child of the master therefore carries the same copyright protection as the master. It is this mass production of a product that is the real problem because, even if the product has been copyright protected, once copyright protection is compromised all the mass produced products can be compromised.

In the film/video industry a piece of software called DeCSS has enabled the general public to remove or alter the DVD regional code, thereby enabling DVDs to be recorded and distributed without the content owner's permission. This one piece of software has now compromised regional protection for the whole DVD industry. Of course, copyright protection is only as good as the programmer who wrote the DVD specification could envisage at the time it was written. As there are many thousands of programmers in the world, it was therefore only a matter of time before the DVD regional protection was compromised.

Similarly, in the music industry, the ability to digitise, compress and send audio files across the Internet and other networks has created piracy problems. This has been further exacerbated by the rise in CD Recorders that enable consumers to duplicate (or “burn”) their CDs at home without paying the relevant royalties to artists, songwriters, record labels and publishers. This has led to an ever increasing level of piracy in the media industries and a rise in copyright protection technology. It has been estimated that the physical aspect of global piracy costs the recording industry over £2.8 bn a year. Last year, approximately 1.2 billion blank CDs were sold in Europe alone—one and a half times the number of music CDs sold in the same period.

The music industry has pointed the finger at illegal music downloads and CD burning for a 10% drop in sales of compact discs in the USA in 2001. The figures, published by the Recording Industry Association of America (RIAA), show that shipments of CDs to retail outlets dropped from 1.08 billion in 2000 to 968.58 million in 2001. A survey carried out by the RIAA also found that almost a quarter of consumers said they are not buying new music because they are downloading or copying music for free.

The value of all music product shipments decreased from $14.3 bn (£10.03 bn) in 2000 to $13.7 bn (£9.6 bn) in 2001, according to the figures released by the RIAA. Last year a similar drop in CD sales prompted some experts to speculate the decrease was part of an industry-wide slump, due to economic factors and a weak year musically. The RIAA study also found that more than 50% of music fans who have downloaded music for free have made copies of it, while two years ago only 13% of fans copied music on to a portable device or a used CD burner. Ownership of CD burners has tripled since 1999, the survey found.

A further problem is that the consumer would like more choice in how he or she obtains music, and on which devices music may be played. Consumers, while on the whole being happy to pay for music, nevertheless want the option to upload songs onto their mobile phone or other handheld devices for their personal use. Many consumers download songs from the Internet to play on their computers. They do not download files and record their own CDs with the downloaded files because the quality of audio files on the Internet is not CD quality and, at present, the Internet is too slow for the majority of consumers to download high quality audio.

It was the phenomenal success of online music services such as Napster which first highlighted the impact of downloaded music to record companies. At the height of its use, Napster had more than 25 million users. It was shut down by record companies in a legal battle over copyright payments, but has spawned a host of similar services such as kazaa.com which uses peer-to-peer technology to share audio data files without the need for a central point of management. Legitimate, paid-for systems launched by the record companies have yet to catch on as many users can still find copied versions of their favourite tracks elsewhere for free on the Internet.

Another factor implicated in the decline of music CD sales is the use of mobile phones and other handheld devices with audio playback capability. The record industry is unable to stop the manufacture of such devices, and would therefore like to produce suitable playback formats which it could license to the device manufacturers. To date, this has not been possible as the formats are not controlled or standardised. Understandably, the record industry wishes to increase the general public's access to music and participate in 3G (third generation), the Internet and new handheld devices and thus increase the demand for music. However, it needs to do this in a way that permits digital distribution of music whilst still supporting its existing CD sales business.

Despite the increase in the use of the Internet, the vast majority of consumers still purchase their music from retail locations such as music stores and supermarkets. Interestingly, the largest group of music CD purchasers in the UK belong to the 28 to 38 age group. Not only do these consumers purchase “current” music CDs, but they also buy CDs of artists they listened to in their teenage years and early twenties, as well as the music of their parents' generation. It has therefore become difficult for retailers to stock such a comprehensive range of music CDs. Fortunately for retailers, customers shop at retail locations for many reasons such as convenience, social and retail experience, price, choice, ease of purchase etc. As retailers constantly refit and re-invent their stores and the services they offer, it is inevitable that the consumer in the future will continue purchase at retail.

To aid understanding of both the problems the music industry in particular faces and the invention described herein, a brief overview of a known audio CD format is now be given. Further details of audio CD formats can be found at the following web site: www.ee.washington.edu/conselec/CE/kuhn/cdaudio2/95x7.htm.

The audio on a CD is divided into a maximum of 99 tracks. Each track must be at least four seconds in length, and a pause of two seconds may be inserted between tracks. The audio may be physically divided into tracks with silence in between, or run continuously between two or more tracks. For each track an ISRC (International Standard Recording Code) should be included to identify that track uniquely. The ISRC comprises 12 characters divided as shown in the table below.

| Length (chars) | Description |
|---|---|
| 2 | Country code |
| 3 | First owner (allocated by Phonographic |
| | Performance Ltd for audio) |
| 2 | Year of recording (the last two digits) |
| 5 | Designation code (assigned by first owner). |

Individual tracks may be further divided into indexes. Usually, a track will contain two indexes: 0 and 1. Index 0 marks the pause (normally two seconds) at the beginning of each track, while index 1 identifies the main part of the track.

Track start times are defined in a table of contents (TOC). The TOC usually includes the timecode for each track (as minutes, seconds and sometimes frames) and is used to enable CD players to “know” where each track is on the CD. The TOC may also define the track type which, for some CD formats, can be audio or data.

In addition to the main data channel (which may contain audio or other data), there are eight subcode channels labelled P to W interleaved with the main channel on the CD. The P-channel indicates the start and end of each track. The Q-channel contains the majority of program and timing information such as timecodes (minutes, seconds and frames), the TOC, track type and catalogue number. Channels R to W are for subcode graphics and CD text which accompany the main audio data.

When recording audio data onto a CD, the data is divided into six samples per channel, i.e. a total of (6×2×16 bits). To this audio data is then added the subcode channels and parity data. This results in a total of 36 bytes which is called a frame, and 98 frames are combined to form a block. Each block of data contains 2352 bytes, and 75 data blocks are read from a CD every second.

A CD player cannot read a CD without first reading the TOC—this is analogous to a boot file of a computer hard disk which needs to be read in order to retrieve relevant data New CDs contain audio and additional data such as band videos and web pages. An example of a multi-session CD format is shown in FIG. 1. This format includes two sessions: an audio session (AS) and a data session (DS). The audio session (AS) commences with a TOC at the start of a lead-in area (LIA). The lead-in area is followed by the audio tracks (AT) (or “songs”—these terms are used interchangeably). In the example shown in FIG. 1, there are 11 audio tracks. The audio session (AS) ends with a lead-out area (LOA) which indicates to the CD player the end of the audio data. The data session (DS) commences with a lead-in area, followed by a data section (DST) and a lead-out area. The audio and data sessions are separated by a link block (LB). The whole data session is regarded as a single track in the TOC.

In the past, pirating CDs was a complicated process requiring investment in expensive machinery. The introduction of CD Recorders (CDRs) has now enabled the general public to copy CDs using a personal computer (PC) provided the correct software is used. The process of copying a CD using a PC is carried out as follows. Firstly, the data on the CD is converted into another format, such as a WAV file. The CD audio is then extracted and the WAV data is written to the PC's hard drive. This process is known as “ripping”. PC CDRs are becoming ever faster at ripping audio, and hence “ripping software” has become more popular and commonplace.

www.CDDB.com is a service which was originally used to provide track and artist names to people so that these details could be displayed on their PCs while playing their CDs. Pirates who name and catalogue illegally ripped songs now frequently use this service and others like it. These types of on-line databases hold the details of millions of CDs with their Table Of Contents (the start and end points of each track) being used as a means of identifying the CD of a particular artist.

When a CD is ripped, the ripper software can contact services like CDDB. A map of the TOC of the CD being copied is read and sent to the CDDB. If the CD cannot be identified by CDDB, then the ripper software asks the user to enter the track and artist details for the CD. If the CD has already been entered into the CDDB, the CDDB queries the database to find an identical TOC map. The ripping software is then sent a list of all the correct track and artist details. The convenience of having all the CD details automatically copied to a user's PC has promoted piracy.

The electronics inside a standard CD player differ to those electronics in a CD Recorder, and many companies have used this difference as a basis for CD copyright protection. Most music CDs produced nowadays are in the multi-session format which, as previously explained, comprises an audio session and a data session. By inserting various errors into the audio and/or data session, the sophisticated reading electronics inside a CDR can be duped into having an error overload and refuse to read the CD. In the commonly known copy protection schemes where the CD has errors in the subcode, the CDR itself does not ‘refuse to read’ the CD, but it is the reading software that refuses to continue reading the CD. Many CD reading software programs can be configured to continue reading error-containing data, but the resultant read data will have errors (usually gaps) in it.

Standard CD audio players do not have such sophisticated reader electronics and use inbuilt circuitry to ignore the errors in the data. A standard CD audio player sees the errors as potential scratches on the CD surface, ignores them and plays the audio. Such errors can include errors in the audio data, misrepresented sector headers and contents, errors in the Table of Contents record or just about anywhere on the CD. These errors can also be malformed subcode information or subcode errors. They can also be incorrectly sized sectors or sub channel information. A malformed TOC in the data session (or additional sessions) of a CD does not prevent a standard audio CD player from reading the CD, as most audio players only read the first session of a CD in any case. It should be noted, however, that newer CD players now available in standard audio hardware are being enabled to play multi-session CDs.

At present, only the audio session is used to identify a CD on the CDDB. However, as some manufacturers have started to introduce errors into the high quality audio to prevent them being read by PC CDRs as a means of copyright protection, a possible (although not implemented at present) extension to the CDDB would be to store maps of these errors and a TOC. If a pirate wanted to rip a copyright protected CD, his ripper could access the CDDB and receive a list of all the errors and their positions on the copyright protected CD. This information could be used to speed up the ripping of these copyright protected CDs. Storing error maps in an online and easily accessible database will always be a potential threat until a method of implementing better copyright protection is found.

With many customers using their PC to play music, some companies have found it necessary to place low quality PC audio files (along with a PC audio player) on the data session of a CD while introducing errors into the audio data. This means that the consumer can only play low quality audio on their PC. Such schemes do make it harder to “rip and copy” CDs, forcing the pirate to use slower and more intelligent software. Companies such as Macrovision and Midbar have heralded the idea of placing errors in the audio data and have used them as part of their copyright protection schemes. However, the errors applied to the master CD and hence are the same for each child CD. Unfortunately, software has already appeared on the Internet to remove these copyright protection schemes. One of the most commonly used methods to do this is called the “RAW method” in which CD data is copied to a hard drive as completely raw binary data. This is known as “cloning” a CD, and creates a CD which is exactly the same as the original CD: if the original CD has copyright protection then the cloned CD also has it. Having been scanned, the RAW CD data is then analysed and any errors are either removed or corrected, and the CD can then be re-recorded without the copyright protection scheme.

In-store manufacture of CDs and other AVDDM (Audio Video Data Distributable Media) has already begun, with companies such as Virtual Music Stores Limited (VMS) installing bespoke album systems in retailers. The VMS System, as it is known, is described in detail in the Applicant's co-pending published International patent application WO 01/37275. Music CDs are provided to VMS by record labels. These CDs are digitised, encrypted, and held on a central server (the Nexus Server) and also on a database at each retail location.

The VMS System is set up to allow a user to prepare a desired song selection from the collection of stored songs. The customer's choice is sent via a network connection to an in-store virtual pressing plant (VPP). The VPP finds the song, instructs a CD robot to place a blank CD in a CD recorder, records the songs onto the CD, and then prints the song details on the CD cover together with the CD itself. If a song is not available locally at the retail location, it may be downloaded from the Nexus Server. The desired songs may be: recorded onto a CD while the customer waits; recorded onto a CD at a different location and sent by mail to the customer's home; downloaded onto a hand-held device while the customer waits within the store; downloaded direct to the customer's computer and recorded onto their own CD recorder; or downloaded onto the hard disk of the customer's computer in a protected format. This service is now being expanded to enable retailers to manufacture CD singles and albums in their stores.

It is an object of the present invention to provide a dynamic copyright protection method. It is another object of the present invention to provide a dynamic copyright protection method which overcomes at least one of the above mentioned disadvantages. A further object of the invention is to provide a dynamic copyright protection method which enables consumers to upload their handheld device/mobile phone with high quality audio while at the same time permitting CD retailers to maintain retail sales. A yet further object of the invention is to provide a method of reading dynamically copyright protected data.

### SUMMARY OF THE INVENTION

According to a first aspect of the invention there is provided a method of recording digital content data onto an AVDDM (Audio Visual Data Distributable Medium), the method comprising: assigning a unique identifier to the AVDDM; using the unique identifier to create a plurality of data errors in, and/or format variations of, the digital content data unique to that AVDDM; and recording the digital content data incorporating the data errors and/or format variations.

This method applies copyright protection to digital content data dynamically and is therefore referred to as a dynamic copyright protection scheme.

As a unique identifier is assigned to each AVDDM, and the unique identifier is used to produce a unique pattern of data errors and/or format variations of the digital content data, every AVDDM which is dynamically copyrighted using the method of the present invention will be unique. Conventional AVDDMs are produced using a master copy and therefore each AVDDM which originates from that master will be identical: services such as CDDB rely on this fact to identify AVDDMs. The advantage that the present invention provides resides in the fact that every AVDDM produced is unique, and it is therefore impossible for services such as CDDB to use to the pattern of data errors and/or format variations as a product identifier.

Preferably the digital content data incorporating the data errors and/or format variations is recorded onto the AVDDM together with the unique identifier. The advantage of this is that the unique identifier enables an AVDDM which has been recorded using the method of the invention to be identified. If the method is carried out at a retail store, for example, the unique identifier may be used to identify the store where the AVDDM was produced and therefore whether or not the AVDDM was legally manufactured.

The format variations may include variations in spacing between items of content recorded on the AVDDM. Taking CDs as an example, the silences at the beginning and/or end of audio data tracks may be varied. Alternatively, or additionally, the silences between audio data tracks may be varied. Adding these silences changes the overall length of the CD and hence when a TOC is created the track start times in the TOC change. Alternatively, the track start times in the TOC may be changed by modifying the TOC without altering the actual data on the CD. These type of format variations assist copyright protection of CDs because every CD has a different audio TOC record, and it thus becomes impossible for services such as CDDB to use the TOC as a product identifier. CDDB will not work on a product (whether it be a CD or other AVDDM) which includes the copyright protection scheme of the present invention.

Preferably the using step comprises inputting the unique identifier into a pseudo random number generator as a seed and creating a random set of data errors and/or format variations for use in the recording step.

A random number may be used to enable the creation of variable errors in the audio session of a CD (or other AVDDM) or the TOC to prevent it being played by a CDR (or other suitable reader). Because the variable errors are generated using the unique identifier, this guarantees that no two AVDDMs have errors in the same position. This discourages users from ripping CDs.

The format variations may also (or alternatively) include variations in the length of one or more digital data sessions of the content recorded on the AVDDM. A random number may be used for the creation of a variable sized data file, or at least one file additional to a digital data session. For example, the details of the artist, song name, track times and any other details may be written to the variable sized data file or an additional file. This prevents services such as CDDB from using the size of the data session of a CD (or other AVDDM) as a product identifier. It also enables customers to access all of the artist names and track details from the AVDDM itself without having to use services such as CDDB.

Preferably the method further comprises compiling an index file (such as a TOC for an audio CD) describing the format and content of the digital content data recorded on the AVDDM. The index file is then preferably recorded onto the AVDDM.

The method may further comprise the creation of a copyright protection map for identifying the unique plurality of data errors in and/or format variations of the digital content data. The copyright protection map may contain the positions of where errors have been placed in the original data, or which parts of the original data have been altered. Alternatively, the copyright protection map may contain the actual missing information from the AVDDM with details of where the missing information originated from. The copyright protection map may subsequently be recorded onto the AVDDM. The advantage of a copyright protection map created in this manner is that because the data errors in and/or format variations of the digital content data are unique for each AVDDM, the resulting copyright protection map will also be unique for each AVDDM. Hence, this prevents services such as CDDB from using the copyright protection map to identify AVDDMs.

The copyright protection map may comprise a plurality of generation routines for generating a list of the plurality of data errors and/or format variations.

In addition to the copyright protection map, a combiner program may also be recorded onto the AVDDM. The combiner program is advantageously arranged to combine the copyright protection map with the digital content data incorporating the data errors and/or format variations to generate the original digital content data for playback by removing the data errors and/or accommodating the format variations. The combiner program ensures that an unprotected copy of the digital content data is not available to the user by preferably substantially simultaneously combining copyright protected data from an AVDDM with the copyright protection map a sector at a time.

Preferably the combiner program is arranged to convert the generated original digital content data into a data format specific to, and supported by, a playback device. For example, the data format may WAV format, or any other suitable format such as an “industry-approved” format. The term playback device refers not only to devices which store and play audio data, but to any device which is able to store audio data which can be subsequently transferred to another device with audio playing capability.

The combiner program may be arranged to playback the original content data on a conventional personal computer without requiring storage of the content data on the personal computer. The advantage of this is that the content data cannot be copied to an AVDDM without the content owner's permission, i.e. to prevent illegal copying of the content data.

Preferably the unique identifier is encrypted and then recorded on the AVDDM. The copyright protection map may be encrypted and recorded on the AVDDM. Encryption of the unique identifier and/or the copyright protection map is preferably carried out using an encryption key which is stored for later use. Encryption of the copyright protection map advantageously provides an additional layer of security.

The digital content data may be compressed using a compression algorithm prior to recording the digital content data on the AVDDM.

According to a second aspect of the invention there is provided an AVDDM (Audio Visual Data Distributable Medium) created using the above method.

According to a third aspect of the invention there is provided an AVDDM (Audio Visual Data Distributable Medium) comprising: a unique identifier to the AVDDM; digital content data incorporating a unique plurality of data errors and/or format variations which have been determined for the AVDDM from the unique identifier to the AVDDM.

A copyright protection map as described previously may be stored in a data session, an audio session, or a sub-code channel of the AVDDM. The copyright protection map may be divided into portions, and each portion may be stored in a different location. So, for example, half of the copyright protection map could be stored in the Q channel and the other half in the R channel. The advantage of this is that it makes the copyright protection map more difficult to extract from the AVDDM.

Compressed digital content data read from the AVDDM may be decompressed by combiner means stored on the AVDDM.

If the copyright protection map is in encrypted form, the combiner means may be arranged to transmit the unique identifier to a remote location over a telecommunications network and to receive a decryption key for decrypting the copyright map. This brings an additional level of security to the copyright protection scheme by ensuring that only authorised user's who are in possession of genuine AVDDMs (and not illegally copied AVDDMs) are able to decrypt the copyright map.

Digital content data stored on the AVDDM may include a digital watermark. Details enabling the data content on the AVDDM (and hence the AVDDM itself) to be uniquely identified are preferably provided in the digital watermark. The advantage of using a digital watermark is that the protection afforded by the unique identifier present in the data session of, for example, a CD can also be afforded to the audio session. If the audio and data sessions are separated, then it is still possible to determine where the audio file originated from. Whilst this security feature can be difficult to police uniformly for all manufactured CDs, (due to the large numbers of CDs), it does provide a deterrent effect. Also, for smaller more valuable first releases and promotional CDs, it enables the source of the copied audio (or other) data to be determined.

According to a fourth aspect of the present invention there is provided a method of transferring digital content data recorded on an AVDDM (Audio Visual Data Distributable Medium) to a playback device at a user's location, the method comprising: reading an encrypted unique AVDDM identifier from the AVDDM; transmitting the unique identifier to a central site from the user's location; decrypting the identifier and using the decrypted identifier to look up a corresponding decryption key; transmitting the decryption key from the central site to the user's location; using the decryption key to decrypt an encrypted copyright map of data errors and/or format variations provided on the AVDDM; reading from the AVDDM, digital content data which has been copyright protected by the inclusion of the data errors and/or the format variations; removing the copyright protection from the digital content data by use of the decrypted copyright map; and recording the digital content data without the copyright protection on to the playback device.

According to a fifth aspect of the present invention there is provided a method of transferring digital content data recorded on an AVDDM (Audio Visual Data Distributable Medium) to a playback device at a user's location, the method comprising: reading a unique AVDDM identifier from the AVDDM; transmitting the unique identifier to a central site from the user's location; receiving a decryption key associated with the unique identifier from the central site; using the decryption key to decrypt an encrypted copyright map of data errors and/or format variations provided in relation to the AVDDM; reading from the AVDDM, digital content data which has been copyright protected by the inclusion of the data errors and/or the format variations; combining the decrypted copyright map with the copyright protected digital content data to remove the copyright protection from the digital content data; and recording the digital content data from which the copyright protection has been removed on to the playback device.

Preferably the method further comprises the step of converting the digital content data from which copyright protection has been removed into a data format for playback on a playback device. Any suitable data formats may be utilised for this step, although industry-approved formats should be used to hinder illegal copying of data. The size of the memory available on the playback device may be used to determine the format, size and quality of the digital content data.

The converting step may include encrypting and/or dynamically copyright protecting the formatted data as it is being uploaded to the playback device.

The formatting step is preferably carried out on apparatus which implements the combining step. Alternatively, the formatting step may be carried out on the playback device itself.

The playback device may have a unique identification number in which case the formatting step may be arranged to format the digital content data for playback on a playback device having that unique identification number.

The playback device may be a mobile telephone such that the unique identification number is the telephone number or customer identifier of the mobile telephone. The transmitting and receiving steps may then be carried out over a wireless telecommunications network.

The formatting step may comprise converting the original digital content data into a format which is unsuitable for playback on a conventional personal computer from a copy of the digital content data stored on the personal computer.

The encrypted copyright map may be provided from the AVDDM by reading the same. Alternatively, it may be provided by receiving the same transmitted from a central site.

The recording step may comprise recording the digital content data on to the playback device with the same audio/visual data quality as that of the digital content data recorded on the AVDDM.

The combiner program may include code which monitors where the data is being transferred to so that, if data is being transferred to a PC hard drive (and not to a playback device), the combiner program will not combine the copyright protection map with the copyright protected data. This provides an additional level of security to hinder the illegal copying of AVDDMs.

There may also be provided a data carrier comprising a computer program arranged to implement the aforedescribed methods of the invention.

### BRIEF DESCRIPTION OF DRAWINGS

Presently preferred embodiments of the present invention will be described, by way of example only, with reference to the following drawings:

FIG. 1 is a schematic representation of a multi-session CD format;

FIG. 2 is a diagram of a system suitable for implementing the first, second and third embodiments of the present invention;

FIG. 3 is a flow diagram showing an overview of the process of producing a dynamically copyright protected CD according to the first, second and third embodiments of the present invention;

FIG. 4a is schematic representation of a VMS Player;

FIG. 4b is a schematic representation of a dynamically copyrighted CD produced using the method illustrated in FIG. 3;

FIGS. 5a, 5b and 5c are flow diagrams showing the detailed steps for implementing respective first, second and third embodiments of the present invention;

FIG. 6 is a flow diagram showing a first method of reading a dynamically copyright protected CD generated using the first, second and/or third embodiments of the present invention;

FIG. 7 is a flow diagram showing a second method of reading a dynamically copyright protected CD generated using the first, second and/or third embodiments, and uploading the data to a hand-held device;

FIG. 8 is a schematic representation of a system for implementing the methods shown in FIGS. 7 and 8; and

FIG. 9 is a flow diagram showing the steps of a network method for authenticating a copyright protected CD, reading the authenticated CD, and uploading the read data to a hand-held device which is suitable for use with any of the embodiments of the present invention.

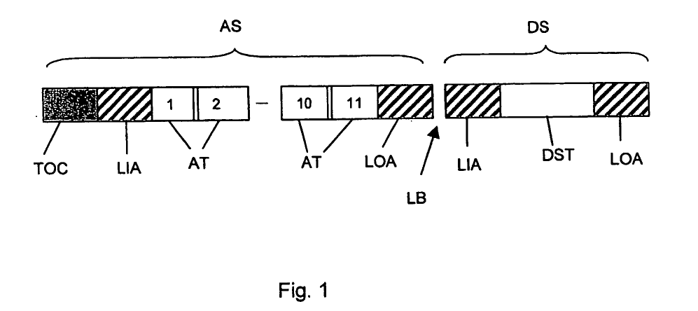

### DETAILED DESCRIPTION OF THE PREFERRED EMBODIMENTS

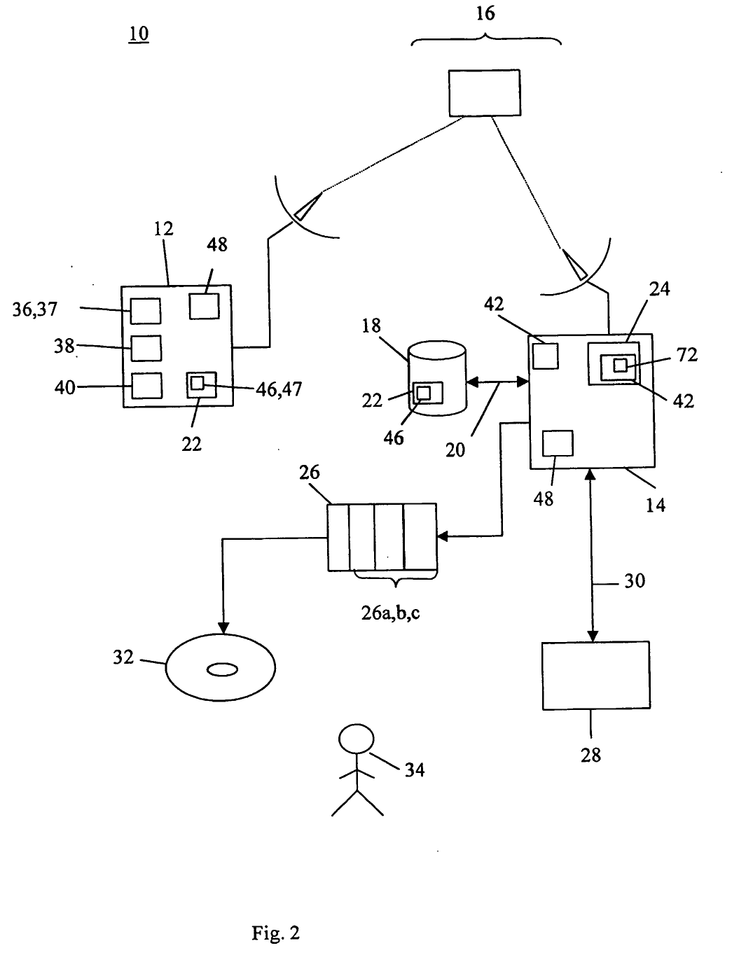

Referring now to FIG. 2, there is shown a system 10 (hereinafter referred to as the VMS System) which is used for implementing first, second and third embodiments of the present invention. The VMS System 10 is capable of delivering all types of audio-visual content such as text, audio, video and graphics to a user 34. In the present embodiments, the VMS System 10 is set up to allow the user 34 to prepare a desired song selection and then have the desired songs recorded on a CD 32 which is given to the user 34. Customers can access the VMS System 10 via high-street terminals or via the Internet.

As shown in FIG. 2, the VMS System 10 comprises a centrally located authentication server 12 (referred to hereinafter as the “Nexus Server”) which is connected to a remote server 14 (referred to hereinafter as the “VPP Server”). The VPP Server 14 in this example is located in a retail store, and is connected to the Nexus Server 12 via a bi-directional encrypted satellite link 16. ADSL, or any other type of broadband access could be used to link retail stores with the Nexus Server 12. Alternatively, the connection 16 could be another type of wireless connection, or even a copper line or cable TV connection.

The VPP Server 14 is connected to a database 18 via, for example, a TCP/IP (i.e. Transmission Control Protocol/Internet Protocol) connection 20. The database 18 stores digitised audio data 22 and other related data 48 such as the artist and track details. The audio data 22 includes a TOC 46 for each song, single and album which is stored on the database 18. The VPP Server 14 contains VPP software 24 for recording data onto a CD 32. The VPP Server 14 also implements dynamic copyright protection by means of a copyright protection map maker 42 (referred to hereinafter as a “CPM Maker”). The CPM Maker 42 includes a pseudo-random/random number generator 72. The VPP Server 14 is coupled to a standard personal computer 26 (PC) and a CD Robot 26a for placing a blank CD into a CD Recorder (not shown). Alternatively, the VPP Server 14 and the PC 26 can be combined into a single unit.

The VPP software 24 controls the CD Robot 26a together with a colour printer 26b which prints CD sleeves, and a CD printer 26c that prints on the surface of the CD 32. The CD Robot 26a, the colour printer 26b and the CD printer 26c are all located in the retail store.

The Nexus Server 12 contains a collection of CD identifiers 36 (CIDs), a plurality of public encryption keys 38 and a plurality of private encryption keys 40. The Nexus Server 12 also contains digitised audio data 22 and related data 48. The database 18 connected to the VPP Server 14 may contain the same audio data 22 (and related data 48) as the Nexus Server 12, or it may contain a subset of this data 22,48. In this manner, the retail store can tailor its available in-store music collection to its target audience whilst reducing the amount of database space required.

To enable the user 34 to browse through the collection of audio data (or “songs”) 22 stored on the VMS Database 18 and/or the Nexus Server 12, a VMS Console 28 is provided in the retail store. The VMS console 28 is connected to the VPP Server 14 via a TCP/IP connection 30.

First, second and third embodiments of the present invention, wherein a dynamically copyrighted VMS CD 32 is produced, are now described.

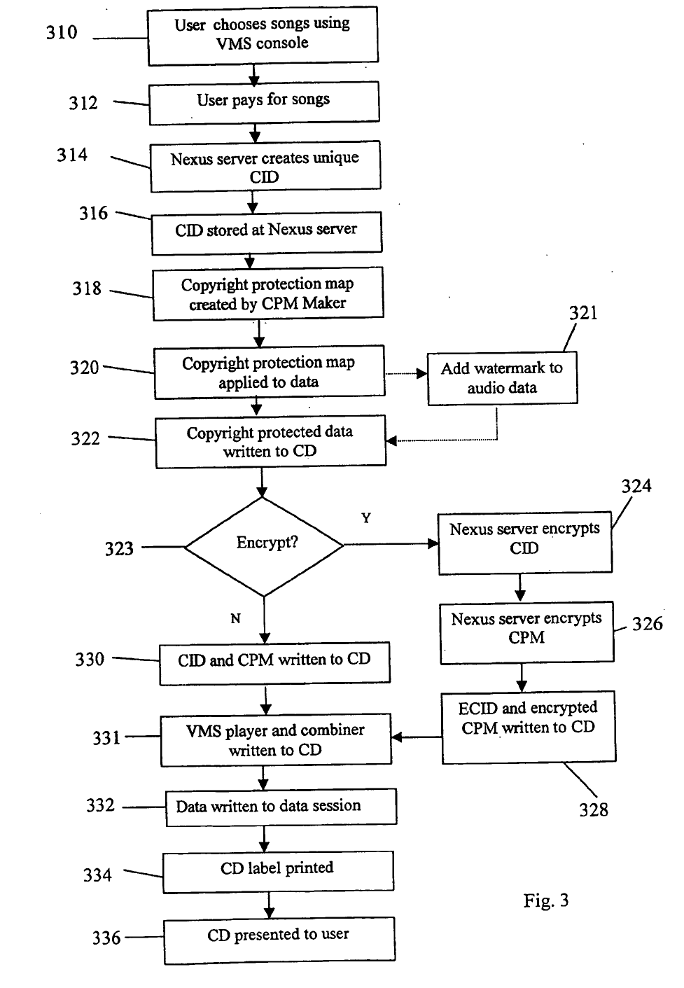

With reference to FIG. 3 of the drawings, there is shown an overview of a method 300 for implementing first, second and third embodiments of the present invention. The method 300 commences with the user 34 choosing at Step 310 a selection of songs 22 from the VMS Database 18 and/or the Nexus Server 12 using the VMS console 28. The user 34 then pays at Step 312 for the CD 32 on which his choice of songs 22 will be recorded at a cash desk in the retail store. Once the user 34 has paid for his CD 32, and this fact has been communicated to the Nexus Server 12, a unique CD identifier (CID) 36 is created at Step 314 by the Nexus Server. In this example, the CID 36 comprises a code for the retail store which produced the CD 32, a time and date stamp, and a number assigned to the CD 32. A different CID 36 is created for each CD produced by the VMS System 10. Next, the CID 36 (or an encrypted version thereof 37) is stored at Step 316 at the Nexus Server 12. A copyright protection map 44 is then created at Step 318 by the CPM Maker 42. The copyright protection map 44 is subsequently applied at Step 320 to the audio data 22 of the song collection, and the related data 48 if required.

An extra layer of copyright protection may be provided by the use of a digital watermark 50 added to the audio data. Such a watermark 50 can be detected by conventional watermarking detection software, but is imperceptible to a listener. If watermarking is required, the optional Step 321 of modifying the audio data 22 to include a watermark 50 is carried out. A unique watermark 50 (such as Central Research Laboratories Limited's Digital Watermark) may be applied to each CD 32 to enable the CD to be identified. Next, the copyright protected audio data 23 is written at Step 322 to the audio session 68 of the CD 32.

Steps 320 and 322 are carried out substantially simultaneously using a method known as “data spray”. This ensures that a virtual copy of the whole CD never exists and is therefore not able to be intercepted and copied by any unauthorised parties. Data spray is explained in the Applicant's co-pending International patent application WO 01/37275. the contents of which are incorporated herein by reference.

In certain situations, it will be necessary to encrypt a portion of the data which is to be written to the CD 32. This might be a condition of a record company allowing its songs to be used by the VMS System 10. If encryption is required (as determined at Step 323), the Nexus Server 12 encrypts at Step 324 the CID 36 using a first public key 38 and saves the encrypted CID 37 for later use. The CPM 44 is then encrypted at Step 326 using a second public key 38. Next, the encrypted CID (known as an “ECID”) and the encrypted CPM 45 (known as an “ECPM”) are written to a data session 70 of the CD 32. If encryption is not required, Steps 324 to 328 will not be carried out. Instead, the unencrypted CID 36 and CPM 44 are written at Step 330 to the data session 70 of the CD 32.

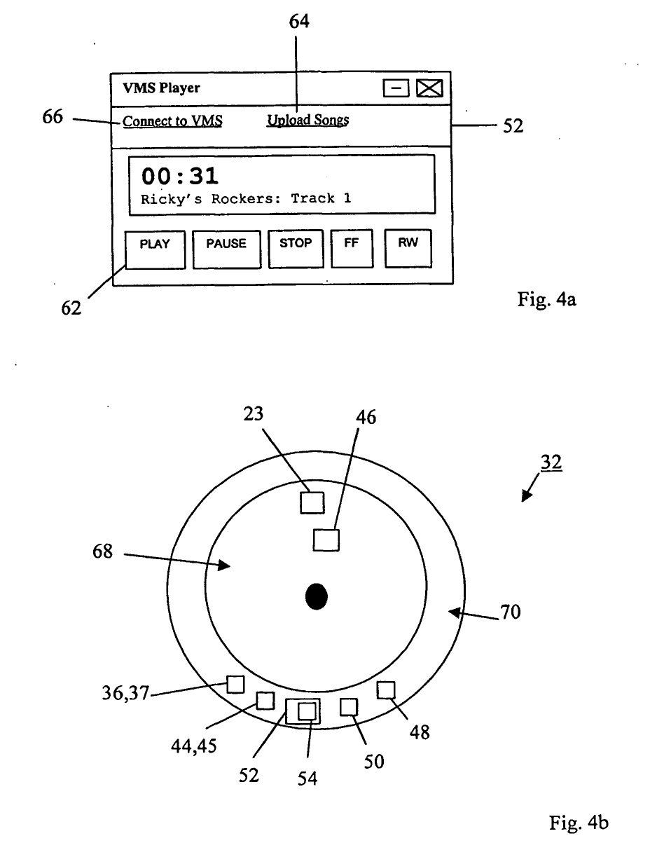

In order to enable the CD 32 to be played on a PC CDR, suitable software is written at Step 331 to the data session 70 of the CD 32. This software takes the form of a VMS Player 52 (see FIG. 4a) and includes a combiner program 54 for combining the CPM 44 with the copyright protected data on the CD 32. The combining procedure is explained in further detail later. Any other data 48 (such as artist and track details) is written at Step 332 to the data session 70 of the CD 32.

As soon as all of the data has been written to the CD 32, a CD label (not shown) is printed at Step 334 by the colour printer 26b and text and/or images may be printed on the CD 32 itself by the CD printer 26c. The completed CD 32 is then presented at Step 336 to the user 34. The resulting CD is shown in FIG. 4b.

Although particular steps of the method 300 have been described as being carried out by either the Nexus Server 12 or the VPP Server 14, it will be appreciated that the VPP Server 14 may run a Nexus Sever application (not shown). Any communication of information between the Nexus Server 12 and the VPP Server 14 via the satellite link 16 will thus be carried out automatically and will be unnoticed by the user 34. So, for example, the unique CID 36 may actually be created by the Nexus Server application running on the VPP Server 14, and the CID 36 may subsequently be sent automatically to the central Nexus Server 12 for storage.

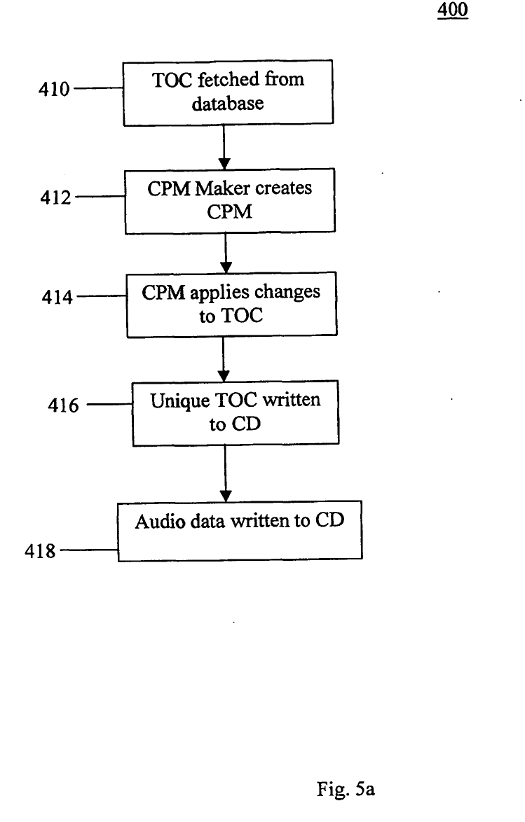

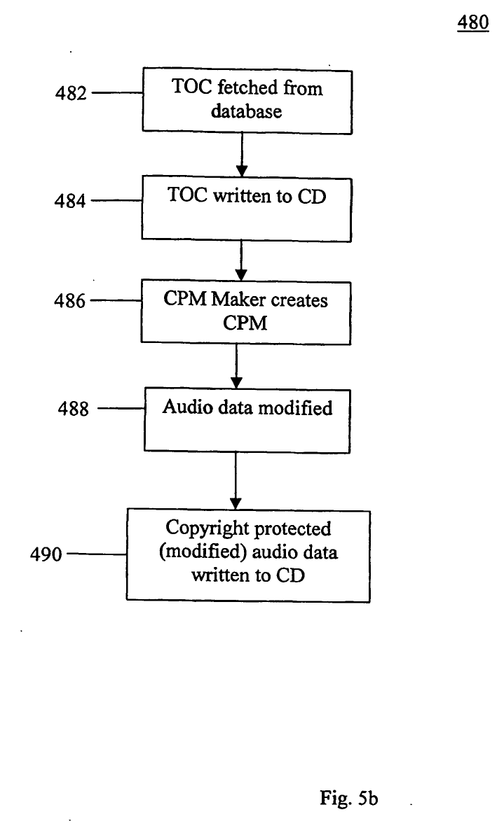

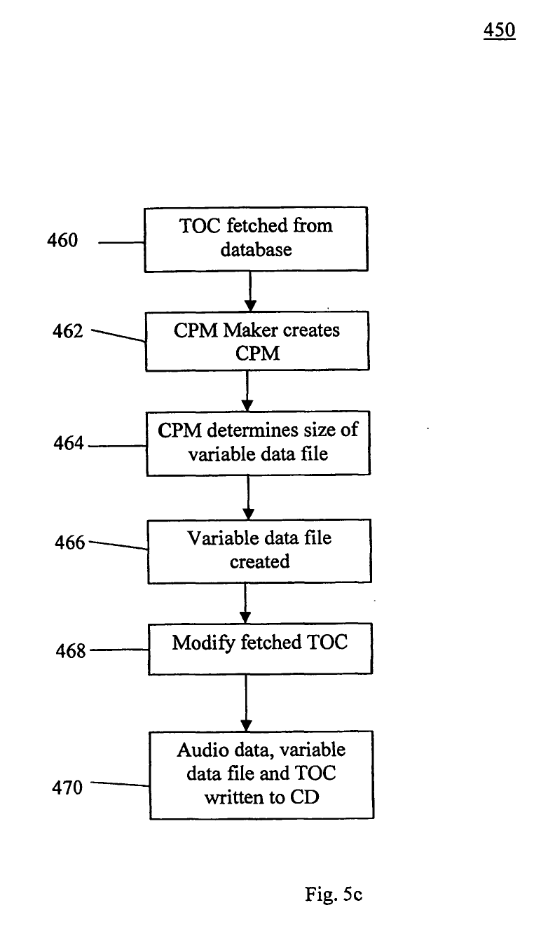

Steps 318 and 320 of the above described method 300 may be carried out in various ways. In a first embodiment of the invention, the silences at one (or a combination) of the following locations of each audio track 22 (or song) are varied: the beginning, the end, between the tracks. Referring now to FIG. 5a, the method 400 of the first embodiment of the present invention is now described.

As discussed in the introduction, the audio session of a multi-session CD contains a table of contents 46 (TOC). When singles and albums are digitised and copied to the Nexus Server 12, the TOC 46 for the single/album is extracted and saved at the server 12 and/or the VMS Database 18 for later use. When individual songs 22 are digitised and saved at the Nexus Server 12, the length of the track is saved at the server 12 and/or the VMS Database 18 for later use.

After the unique CID 36 has been created and saved in Steps 314 and 316 of the method 300, the CID 36 is passed to the CPM Maker 42. If the user 34 wishes to copy a complete album to his CD 32, the CPM Maker 42 fetches at Step 410 the TOC 46 for that particular album from the VMS Database 18. If the VMS Database 18 does not hold that particular album, then the VPP Server 14 contacts the Nexus Server 12 to request a copy of the TOC 46 stored there; The TOC 46 will then be sent to the VPP Server 14 via the satellite link 16. Where the user 34 has requested a collection of songs, a TOC 46 will be created at Step 410 using the lengths of the songs 22 which have been stored by the VMS System 10.

Next, the CPM Maker 42 creates at Step 412 the CPM 44. This is carried out by passing the unique CID 36 to the pseudo-random/random number generator 72 and using the CID as a seed number to generate a random or pseudo-random number. The pseudo-random/random number is used to vary the length of the silences specified in the TOC 46. Suppose the user 34 has selected an old Rolling Stones EP having three songs 22 (or “tracks”), and the EP is not available on CD. The TOC 46 for the three tracks was stored by the VMS System 10 when the EP was digitised, and appears as follows:

| | |
|---|---|
| 01 | 00:02:11 |
| 02 | 10:48:01 |
| 03 | 18:01:43 |
| LOA | 25:38:51 |

In the above table, the first column specifies the track number, and the second column specifies the start time of the track. So, the first track begins just over two seconds from the start of the audio data. The pseudo-random/random number is used to add (or subtract) time periods from the TOC 46. Let the random time period produced by the CPM Maker 42 for the first track be 0.05 second, while that of the second and third tracks is 0.1 second. The CPM 44 generated would then be as follows:

| | |
|---|---|
| 01 | +00:00:05 |
| 02 | +00:00:10 |
| 03 | +00:00:10 |

The next step of method involves the above CPM 44 being applied at Step 414 to the TOC 46 to give the following modified TOC 47:

| | |
|---|---|
| 01 | 00:02:16 |
| 02 | 10:48:11 |
| 03 | 18:01:53 |
| LOA | 25:38:51 |

This unique TOC 46 is subsequently written at Step 416 to the audio session 68 of the CD 32. Finally, the three audio tracks 22 are written at Step 418 to the CD 32. Steps 324 to 334 or Steps 330 to 334 of the method 300 are then carried out as described previously.

As a CID 36 created for a particular CD 32 is unique, each pseudo-random/random number generated will be unique, and thus the resulting modified TOC 47 will also be unique. This assists in copyright protection of the CD 32 as it becomes impossible for services such as CDDB to use the modified TOC 47 as a product identifier for identifying, say, the Rolling Stones EP. The changes made to the original TOC 46 only need to be a few hundredths of a second in length to ensure that the modified TOC 47 is noticeably different for each CD 32 produced: another CD produced by the VMS System 10 which has the same Rolling Stones EP recorded on it will have a different modified TOC 47. Also, the above modifications do not have to be made to the data itself: they could just be applied to the relevant parts of the TOC 46 to produce a modified 47. The CDDB service will not work on a VMS product once this embodiment of the invention has been implemented.

A method 480 for implementing the second embodiment of the present invention is now described with reference to FIG. 5b. In this embodiment, variable errors are applied to the audio data 22 and/or the TOC 46. As in the first embodiment of the invention, the TOC 46 for the selected album or single is fetched at Step 482 from the VMS Database 18 (or the Nexus Server 12). If the user 34 has requested a selection of songs, a TOC 46 will be created at Step 482. The TOC 46 is then written at Step 484 to the audio session 68 of the CD 32.

Next, the CPM Maker 42 creates at Step 484 a unique CPM 44 from the unique CD 36. This is carried out by passing the CID 36 to the pseudo-random/random number generator 72. The CID 36 is used as a seed number to generate a random or pseudo-random number. As stated previously, although this step is described as being carried out by the VPP Server 14, it could in fact be carried out by the Nexus Server 12 with the pseudo-random/random number being communicated to the VPP Server 14 via the satellite connection 16.

The pseudo-random/random number is used to specify random locations of errors which are to be created in the audio session 68 of the CD 32. For example, a random number may specify individual bits of the audio data 22 which should be changed either from 0 to 1, or from 1 to 0. Step 484 of the method 480 also involves the CPM 44 storing a list of these locations of the varied bits. At Step 488, the bits of the audio data 22 specified in the CPM 44 are changed accordingly. The TOC 46 is then written at Step 488 to the CD 32, and finally the modified (i.e. copyright protected) audio data 23 is written at Step 490 to the audio session 68 of the CD 32. Steps 324 to 334 or Steps 330 to 334 of the method 300 are then carried out as previously described.

As the unique CID 36 is used to generate errors at random positions in the audio data 22, every CD 32 produced by the VMS System 10 which includes this type of copyright protection will also be unique. Consequently, pirates will not be able to use databases of error maps to identify CDs and thus VMS CDs 32 cannot be ripped in the same way as Macrovision and Midbar copyright protected CDs are ripped. Additionally, this embodiment of the invention provides a CD 32 having audio data 22 which can be played by a conventional audio CD player, but which cannot be played by a PC CDR and therefore cannot be easily copied. This is because an audio CD player will interpret the errors in the audio data as scratches on the surface of the CD 32, and it will apply error correction accordingly. A PC CDR will not perform error correction on the audio data, and thus the errors will be heard as a series of clicks or jumps and/or the CDR may refuse to play the CD 32 at all.

The method 480 may be used to apply random errors to the TOC 46 as well as (or instead of) errors in the audio data 22 itself. Again, this will have the effect of dissuading database services such as CDDB from storing error maps to identify CDs, as each CD 32 produced by the VMS System 10 has a unique error pattern.

A method 450 of implementing the third embodiment of the present invention is now described with reference to FIG. 5c. As in the first and second embodiments, the TOC 46 is fetched (or created) at Step 460 from the VMS Database 18 (or the Nexus Server 12). The CPM Maker 42 then creates at Step 462 a unique CPM 44 using the unique CID 36 as a seed number for input to the pseudo-random/random number generator 72 thereby generating a pseudo-random/random number. The pseudo-random/random number is used to determine at Step 464 the size of a data file 48 (previously referred to as other data) which is to be recorded onto the data session of the CD 32. The data file 48 may either remain blank, or it may be used to store artist and track details. If the data file 48 is to remain blank, a blank data file 48 of the size specified by the pseudo-random/random number is created at Step 466. If a data file 48 including the artist and track details already exists, then Step 466 will include modifying the size of this file as specified by the pseudo-random/random number. This may be carried out by, for example, adding a few hundredths of seconds of silence to the data file 48. Then the TOC 46 is modified at Step 468 to reflect the modified size of the data file 48. Finally, in the last step of the method 450 the audio data 22 is written at Step 470 to the audio session of the CD 32, the data file 48 is written to the CD's data session 70, and the modified TOC 47 is written to the audio session 68 of the CD 32.

Since the length of the data session 70 is included in the TOC 46 as an audio track, a CD 32 having a uniquely sized data file 48 will produce a unique TOC as the start and end points of the data session will be unique for every CD. This assists in copyright protection as it dissuades database services such as CDDB from using the size of the data file 48 to identify a CD. This embodiment of the invention also enables users 34 to access the details of the artist and the tracks recorded on the CD 32 without having to use CDDB.

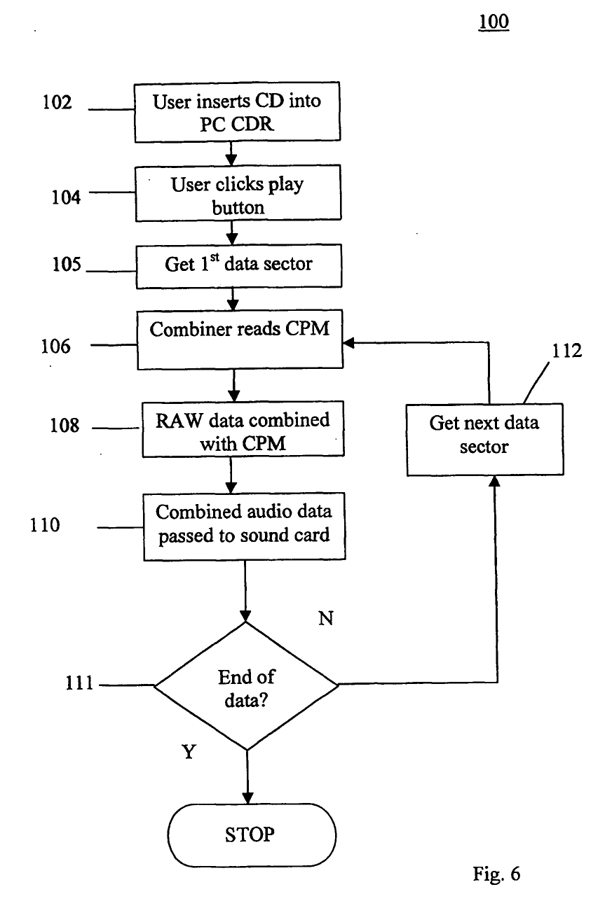

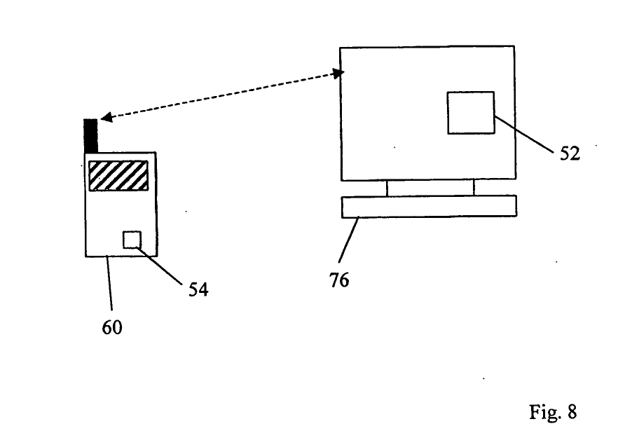

Now that the methods 400, 450 and 480 by which a copyright protected CD 32 is produced has been explained, two local (i.e. non-network) methods 100 and 120 of reading the CD 32 on a PC are now described with reference to FIGS. 5 and 6. Conventional audio CD players are able to play VMS CDs incorporating copyright protection implemented using the first, second and third embodiments of the present invention. However, dedicated software 52,54 is required to read the CD 32 using a PC CDR. A system 74 for playing copyright protected CDs is shown in FIG. 8. The system 74 comprises a PC 76 connected to a hand-held device 60 via, for example an IR, Bluetooth™, wireless, USB, or other suitable connection.

Referring to FIG. 6, the first method 100 of reading a copyright protected CD 32 commences with the user 34 inserting at Step 102 the CD 32 into his PC CDR and thereby automatically launching the VMS Player 52. The user 34 then clicks at Step 104 on the play button 62 displayed by the VMS Player. The combiner program 54 (which forms part of the VMS Player software) then reads at Step 105 the first sector of RAW copyright protected data from the CD 32. The combiner program 54 then reads at Step 106 the relevant portion of the CPM 44 from the CD 32. Then, the first sector of RAW copyright protected data is “combined” at Step 108 with the relevant portion of the CPM 44 (if necessary) to form the original, non-copyright protected audio data 22. The “combined” (i.e. original) first sector of CD audio data is then passed at Step 110 directly to the sound card or audio system and played via the PC audio system. The combiner checks at Step 111 whether there is more data to be read from the CD. If there is, the combiner program 54 gets at Step 112 the next data sector. Steps 106 to 112 are repeated until all the data has been read from the CD 32. This method 100 has the effect that separate, low quality PC audio files are not required. Also, as the data spray method is used to play the audio data, a complete version of the uncopyright protected data is never available to the user.

The method by which the combiner program 54 combines the copyright protected data with the CPM 44 will, of course, depend on the type of copyright protection applied to the CD 32. For example, if the copyright protected audio data 22 on the CD 32 includes random errors (as implemented by the second embodiment of the invention) the CPM 44 will comprise a list of the locations of these errors. While the CD 32 is being played by the VMS Player 52, the combiner program 54 will thus correct the errors at the locations specified by the CPM 44 before the data is passed to the sound card/audio system. Error correction is carried out in real-time without saving a copy of the original, non-copyright protected data 22.

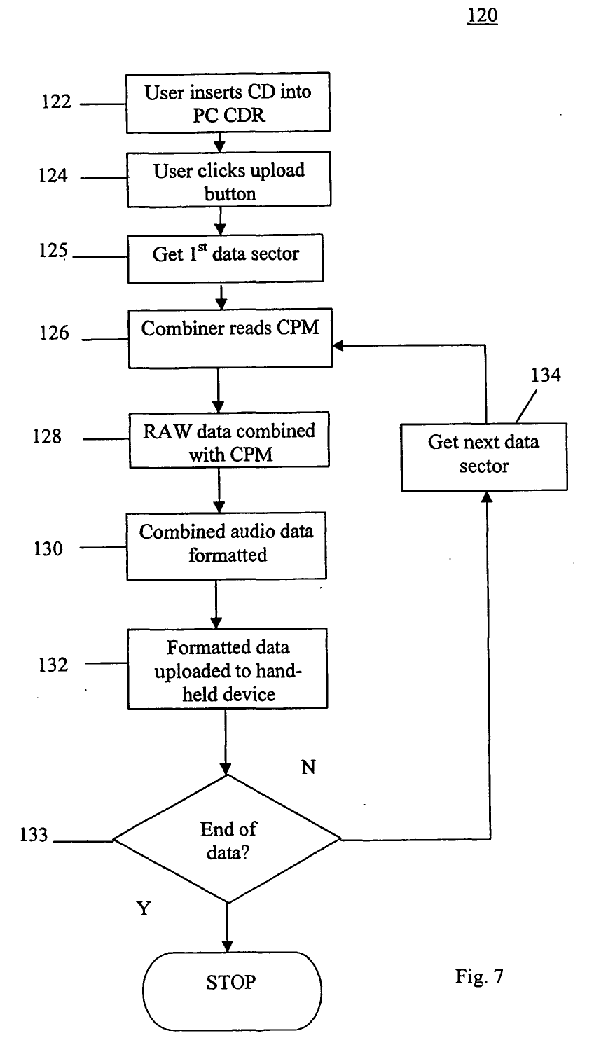

The VMS Player 52 can also be used to upload data from the copyright protected CD 32 to a hand-held device 60 using the second method 120 illustrated in FIG. 7. The user 34 inserts at Step 122 the CD 32 into his PC CDR, and the VMS player 52 is automatically launched. The user 34 then clicks on the “upload songs” button 64 displayed by the VMS Player 52.

The combiner program 54 then reads at Step 125 the first sector of RAW copyright protected data from the CD 32. The combiner program 54 then reads at Step 126 the relevant portion of the CPM 44 from the CD 32. Then, the first sector of RAW copyright protected data is “combined” at Step 128 with the relevant portion of the CPM 44 (if necessary) to form the original, non-copyright protected audio data 22. The “combined” (i.e. original) first sector of CD audio data is then converted at Step 130 into a format that can be uploaded directly to a hand-held device 60, and the formatted data is uploaded at Step 132 to the hand-held device 60. The combiner checks at Step 133 whether there is more data to be read from the CD. If there is, the combiner program 54 gets at Step 134 the next data sector. Steps 126 to 134 are repeated until all the data has been read from the CD 32 and uploaded to the hand-held device 60. In this manner, high-quality 16 bit 44 kHz audio data is uploaded to the hand-held device 60 via the VMS Player 52.

The above described methods 100 and 120 provide a solution which does not require any authentication of the user 34. A user can therefore purchase a CD 32 and upload it to their hand-held device 60 without needing to register or fill out forms. The methods 100 and 120 also enable a copyright protected format to be used with hand-held devices and thus expand the customer take-up and acceptance of these devices. When the cost of downloading songs directly via mobile phones becomes less prohibitive, the customer can easily migrate from uploading songs via their CDs to a network authentication method, which would be an even more secure way of implementing dynamic copyright protection. The customer will not be able to copy the CD onto their computer and play it unless they can combine the CD RAW data with the copyright protection map and, if they do manage to “crack” the copyright protection scheme, they will only have done so for a single particular CD.

A stronger copyright protection system may nevertheless be provided by providing an authentication process which must be carried out before audio data can be uploaded to a hand-held device 60. The authentication process is carried out by sending the encrypted CID 36 to the Nexus Server 12. The encrypted CID 36 can then be used as a database access key to obtain access to facilities and services provided by the VMS System 10.

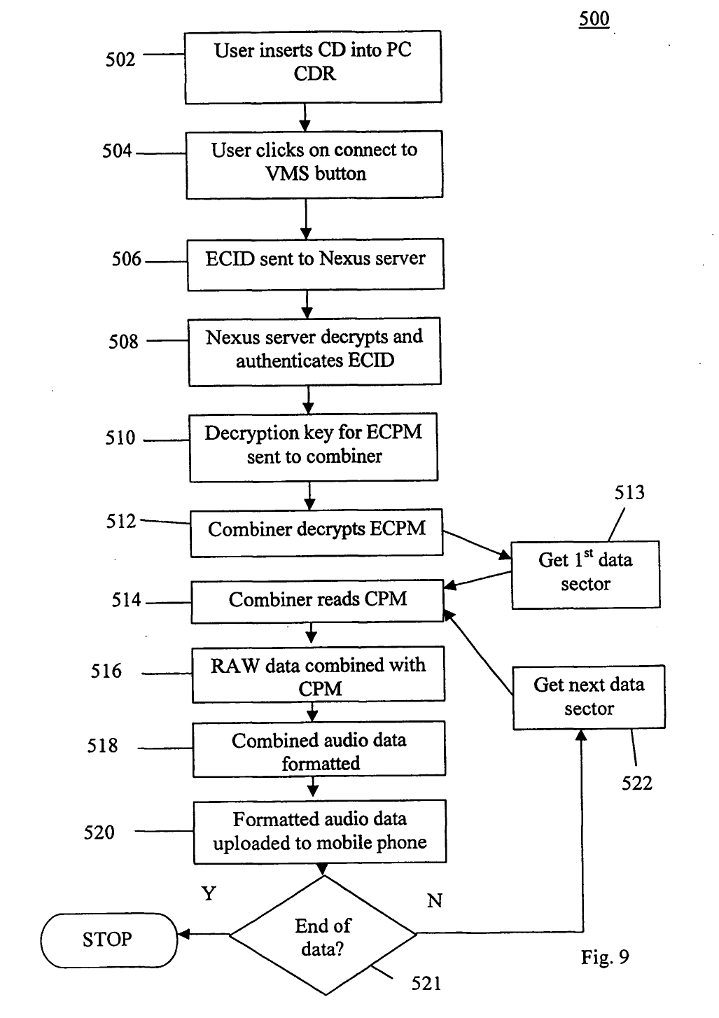

With reference to FIG. 9, there is shown a network method 500 for carrying out the authentication process and uploading data from a copyright protected CD 32 to a hand-held device 60. The method 500 commences with the user 34 inserting at Step 502 the CD 32 into his PC CDR and the VMS player 52 being launched automatically. The user 34 then clicks on the “connect to VMS” button 64 displayed by the VMS Player 52. The VMS Player 52 connects to the Nexus Server 12, and then sends at Step 506 the encrypted CID 37 to the server 12. The Nexus Server 12 decrypts the ECID 37 using the appropriate private key, and authenticates at Step 508 the CID 36. The authentication step is carried out by matching the CID 36 received from the user 34 against the list of CIDs 36 stored at the Nexus Server 12. If the received CID 36 matches one of the stored CIDs, the Nexus Server 12 “knows” that the VMS System 10 was used to create the CD 32 and that the CD has been paid for. If the CID 36 (and therefore the CD 32) is authentic, the Nexus Server 12 sends at Step 510 to the VMS Player 52 the appropriate private key 40 for decrypting the ECPM 45. The ECPM 45 is then decrypted at Step 512 by the combiner software 54 to give the original CPM 44 which is stored on the user's PC for later use, for example.

The combiner program 54 then reads at Step 125 the first sector of RAW copyright protected data from the CD 32. The combiner program 54 then reads at Step 514 the relevant portion of the stored CPM 44. Then, the first sector of RAW copyright protected data is “combined” at Step 516 with the relevant portion of the CPM 44 (if necessary) to form the original, non-copyright protected audio data 22. The “combined” (i.e. original) first sector of CD audio data is then converted at Step 518 into a format that can be uploaded directly to a hand-held device 60, and the formatted data is uploaded at Step 520 to the hand-held device 60. The combiner checks at Step 521 whether there is more data to be read from the CD. If there is, the combiner program 54 gets at Step 522 the next data sector. Steps 514 to 522 are repeated until all the data has been read from the CD 32 and uploaded to the hand-held device 60.

The above described method 500 can be used to transfer audio data directly from the Nexus server 12 to the user's hand-held device 60. For example, in Step 506 the VMS Player may connect to the Nexus Server 12 via a mobile phone 60, and the encrypted CID is thus sent from a user's PC to his mobile phone 60 and then to the Nexus Server 12. Step 508 is then implemented as described above. However, at Step 510, the decryption key 40 will be sent directly to the user's mobile phone 60 whereupon it can be transmitted to the VMS Player on the user's PC so that the encrypted CPM 45 can be decrypted.

In a further method of reading and uploading a dynamically copyright protected CD, the combiner program 54 is actually installed on the mobile phone 60. The encrypted CPM 47 is sent to the mobile phone 60 from the PC so that it can be decrypted. Copyright protected data from the Nexus Server 12 can then be downloaded directly to the phone 60 for combining with the decrypted CPM. In this manner, a user who is in possession of an authentic CD 32 may use the CD to gain access to the Nexus Server 12 to possibly download additional songs or artist information. This is provides an incentive for users to purchase legitimate CDs rather than copying a CD from a friend or from the Internet.

In summary, the present invention is based on the fact that every product (whether it be a CD or other AVDDM) produced by the VMS System 10 is different, i.e., the product is never mass-produced. This is made possible by in-store point of sale manufacturing or by using CDR at the CD manufacturing plant. Products produced in this manner can be played on standard CD players or PCs. The consumer can upload their music to a mobile phone or other hand-held device. The full bandwidth audio on the CD is accessed and used by combining the copyright protected audio with a copyright protection map to produce the original uncopyrighted data. In the uploading of data to a hand-held device, the quality of the audio is only restricted by the size of the hand-held device's memory or hard drive. If the consumer has access to broadband, there is no reason why dynamic copyright protection could not be used to create copyright protected CDs at the customer's home.

Having described a number of embodiments of the present invention, it is to be appreciated that the embodiments in question are exemplary only, and that variations and modifications such as will occur to those possessed of the appropriate skills and knowledge may be made without departing from the spirit and scope of the invention as set forth in the appended claims. For example, even though the dynamic copyright protection of an audio CD has been described, it will be appreciated that any other suitable AVDDM such as a DVD (and corresponding formats) may be dynamically copyrighted and read using the present invention. The present invention may also be applied to other suitable CD formats. For example, the method of varying the start times of the tracks and adjusting the TOC accordingly may be carried out for the older style (Red Book) CDs which have no data session.

Rather than the CD (or other AVDDM) itself containing a copy of the copyright protection map (whether encrypted or unencrypted), the combiner program may contain a copyright protection map generation routine (not shown). Therefore, when the user inserts his CD into a CDR, in addition to the VMS Player being launched automatically, the combiner program 54 will run the CPM generation routine to generate the CPM in real time. The CPM generation routine contained within the combiner program would be identical to that provided by the VPP Server 14. As the unique CID has been used to generate the CPM at the VPP Server 14, the CPM generation routine implemented by the combiner 54 would take as its input the CID. That is, the CID is used by the CPM generation routines to identify the particular combination of copyright protection methods which were used to generate the CPM at the VPP Server 14.

Additionally, although only the uploading of audio data to mobile phones has been described, it will be appreciated that such data may be uploaded to other portable devices such as personal digital assistants (PDAs), portable hard drives or any other device capable of storing and/or playing audio or visual data.

1. A method of recording digital content data onto an AVDDM (Audio Visual Data Distributable Medium), the method comprising:
assigning a unique identifier to the AVDDM;
using the unique identifier to create a plurality of data errors in and/or format variations of the digital content data unique to that AVDDM; and
recording the digital content data incorporating the data errors and/or format variations onto the AVDDM.

2. A method according to claim 1, wherein the recording step comprises recording the digital content data incorporating the data errors and/or format variations together with the unique identifier onto the AVDDM.

3. A method according to claim 1, wherein the using step comprises inputting the unique identifier into a pseudo random number generator as a seed and creating a random set of data errors and/or format variations for using in the recording step.

4. A method according to claim 1, wherein the format variations include variations in spacing between items of content recorded on the AVDDM.

5. A method according to claim 1, wherein the format variations include variations in the length of one or more digital data sessions of the content recorded on the AVDDM.

6. A method according to claim 1, wherein the format variations include at least one data file additional to a digital data session of the content recorded on the AVDDM.

7. A method according to claim 1, further comprising compiling an index file describing the format and content of the digital content data recorded on the AVDDM, and wherein the recording step further comprises recording the index file onto the AVDDM.

8. A method according to claim 1, further comprising creating a copyright protection map for identifying the unique plurality of data errors in and/or format variations of the digital content data; and wherein the recording step further comprises recording the copyright protection map onto the AVDDM.

9. A method according to claim 8, wherein the creating step comprises creating a copyright protection map listing the plurality of data errors and/or format variations.

10. A method according to claim 8, wherein the creating step comprises creating a copyright protection map comprising a plurality of generation routines for generating a list of the plurality of data errors and/or format variations.

11. A method according to claim 8, wherein the recording step further comprises recording a combiner program onto the AVDDM, the combiner program being arranged to be used to combine the copyright protection map with the digital content data incorporating the data errors and/or format variations to generate the original digital content data for playback by removing the data errors and/or accommodating the format variations.

12. A method according to claim 11, wherein the combiner program is arranged to convert the generated original digital content data into a data format specific to and supported by a playback device.

13. A method according to claim 11, wherein the combiner program is arranged to playback the original content data on a conventional personal computer without requiring storage of the content data on the personal computer.

14. A method according to claim 8, further comprising encrypting the unique identifier and wherein the recording step comprises recording the encrypted identifier on to the AVDDM.

15. A method according to claim 14, further comprising encrypting the copyright protection map and wherein the recording step comprises recording the copyright protection map on the AVDDM.

16. A method according to claim 14, further comprising carrying out the encryption step using an encryption key and storing the encryption key for later use.

17. A method according to claim 1, further comprising compressing the digital content data using a compression algorithm prior to recording the digital content data on the AVDDM.

18. An AVDDM (Audio Visual Data Distributable Medium) created by a method according to claim 1.

19. An AVDDM (Audio Visual Data Distributable Medium) comprising:
a unique identifier to the AVDDM;
digital content data incorporating a unique plurality of data errors and/or format variations which have been determined for the AVDDM from the unique identifier to the AVDDM.

20. An AVDDM according to claim 19, wherein the format variations include variations in spacing between items of content recorded on the AVDDM.

21. An AVDDM according to claim 19, wherein the format variations include variations in the length of one or more digital data sessions of the content recorded on the AVDDM.

22. An AVDDM according to any of claims 19, further comprising an index file describing the format and content of the digital content data recorded on the AVDDM.

23. An AVDDM according to claims 19, further comprising a copyright protection map for identifying the unique plurality of data errors in and/or format variations of the digital content data.

24. An AVDDM according to claim 23, wherein the copyright protection map is stored in a data session of the AVDDM.

25. An AVDDM according to claim 23, wherein the copyright protection map is stored in an audio session of the AVDDM.

26. An AVDDM according to claim 23, wherein the copyright protection map is stored in a sub code channel of the AVDDM.

27. An AVDDM according to claim 26, wherein the copyright protection map comprises a plurality of portions, and the plurality of portions of the copyright protection map are stored in a respective plurality of sub code channels of the AVDDM.

28. An AVDDM according to claims 23, further comprising a combiner, the combiner being arranged, in use, to combine the copyright protection map with the digital content data incorporating the data errors and/or format variations to generate the original unprotected digital content data by removing the data errors and/or accommodating the format variations.

29. An AVDDM according to claim 28, wherein the combiner is arranged to decompress compressed digital content data read from the AVDDM.

30. An AVDDM according to claim 29, wherein the copyright protection map is encrypted and the combiner is arranged to transmit the unique identifier to a remote location over a telecommunications network and to receive a decryption key for decrypting the copyright protection map.

31. An AVDDM according to claims 19, wherein the digital content data includes a digital watermark.

32. A method of transferring digital content data recorded on an AVDDM (Audio Visual Data Distributable Medium) to a playback device at a user's location, the method comprising:
reading an encrypted unique AVDDM identifier from the AVDDM;
transmitting the unique identifier to a central site from the user's location;
decrypting the identifier and using the decrypted identifier to look up a corresponding decryption key;
transmitting the decryption key from the central site to the user's location;
using the decryption key to decrypt an encrypted copyright map of data errors and/or format variations provided on the AVDDM;
reading from the AVDDM, digital content data which has been copyright protected by the inclusion of the data errors and/or the format variations;
removing the copyright protection from the digital content data by use of the decrypted copyright map; and
recording the digital content data without the copyright protection on to the playback device.

33. A method of transferring digital content data recorded on an AVDDM (Audio Visual Data Distributable Medium) to a playback device at a user's location, the method comprising:
reading a unique AVDDM identifier from the AVDDM;
transmitting the unique identifier to a central site from the user's location;
receiving a decryption key associated with the unique identifier from the central site;
using the decryption key to decrypt an encrypted copyright map of data errors and/or format variations provided in relation to the AVDDM;
reading from the AVDDM, digital content data which has been copyright protected by the inclusion of the data errors and/or the format variations;
combining the decrypted copyright map with the copyright protected digital content data to remove the copyright protection from the digital content data; and
recording the digital content data from which the copyright protection has been removed on to the playback device.

34. A method according to claim 33, further comprising converting the digital content data from which copyright protection has been removed into a data format for playback on a playback device.

35. A method according to claim 34, wherein the converting step is carried out on apparatus which implements the combining step.

36. A method according to claim 34, wherein the converting step is carried out on the playback device.

37. A method according to claim 36, wherein the playback device has a unique identification number and the converting step is arranged to format the digital content data for playback on a playback device having that unique identification number.

38. A method according to claim 37, wherein the playback device is a mobile telephone and the unique identification number is the telephone number or customer identifier of the mobile telephone.

39. A method according to claims 34, wherein the converting step comprises converting the original digital content data into a format which is unsuitable for playback on a conventional personal computer from a copy of the digital content data stored on the personal computer.

40. A method according to claims 33, wherein the encrypted copyright map is provided from the AVDDM by reading the same.

41. A method according to claims 33, wherein the encrypted copyright map is provided by receiving the same transmitted from the central site.

42. A method according to claims 33, wherein recording step comprises recording the digital content data on to the playback device with the same audio/visual data quality as that of the digital content data recorded on the AVDDM.

43. A method according to claims 33, wherein the playback device comprises a mobile telephone and the transmitting and receiving steps are carried out over a wireless telecommunications network.

44. A method according to claim 39, wherein the converting step further comprises encrypting the original digital content data.

45. A method according to claim 39, wherein the converting step further comprises copyright protecting the original digital content data.

46. A computer-readable medium/electrical carrier signal encoded with a program for causing a computer to perform the method of claim 1.

47. A method of recording digital content data onto an AVDDM (Audio Visual Data Distributable Medium), the method comprising:
assigning a unique identifier to the AVDDM;
inputting the unique identifier into a pseudo random number generator as a seed and creating a random set of data errors and/or format variations of the digital data content data unique to that AVDDM; and
recording the digital content data incorporating the data errors and/or format variations together with the unique identifier onto the AVDDM.

48. A method of recording digital content data onto an AVDDM (Audio Visual Data Distributable Medium), the method comprising:
assigning a unique identifier to the AVDDM;
inputting the unique identifier into a pseudo random number generator as a seed and creating a random set of data errors and/or format variations of the digital data content data unique to that AVDDM; and
recording the digital content data incorporating the data errors and/or format variations onto the AVDDM.

49. A method according to claim 48, wherein the format variations include variations in spacing between items of content recorded on the AVDDM.

50. A method according to claim 48, wherein the format variations include variations in the length of one or more digital data sessions of the content recorded on the AVDDM.

51. A method according to claim 48, wherein the format variations include at least one data file additional to a digital data session of the content recorded on the AVDDM.

52. A method of recording digital content data onto an AVDDM (Audio Visual Data Distributable Medium), the method comprising:
assigning a unique identifier to the AVDDM;
using the unique identifier to create a plurality of data errors in and/or format variations of the digital content data unique to that AVDDM;
creating a copyright protection map for identifying the unique plurality of data errors in and/or format variations of the digital content data, the copyright protection map comprising a plurality of generation routines for generating a list of the plurality of data errors and/or format variations; and
recording the digital content data incorporating the data errors and/or format variations and the copyright protection map onto the AVDDM.

53. A method of recording digital content data onto an AVDDM (Audio Visual Data Distributable Medium), the method comprising:
assigning a unique identifier to the AVDDM;
using the unique identifier to create a plurality of data errors in and/or format variations of the original digital content data unique to that AVDDM;
creating a copyright protection map listing the plurality of data errors and/or format variations of the digital content data; and
recording the digital content data incorporating the data errors and/or format variations, the copyright protection map, and a combiner program onto the AVDDM, the combiner program being arranged to be used to combine the copyright protection map with the digital content data incorporating the data errors and/or format variations to generate the original digital content data for playback by removing the data errors and/or accommodating the format variations.

54. A method of recording digital content data onto an AVDDM (Audio Visual Data Distributable Medium), the method comprising:
assigning a unique identifier to the AVDDM;
using the unique identifier to create a plurality of data errors in and/or format variations of the original digital content data unique to that AVDDM;
creating a copyright protection map for identifying the unique plurality of data errors in and/or format variations of the digital content data; and
recording the digital content data incorporating the data errors and/or format variations, the copyright protection map, and a combiner program onto the AVDDM, the combiner program being arranged to be used to combine the copyright protection map with the digital content data incorporating the data errors and/or format variations to generate the original digital content data for playback by removing the data errors and/or accommodating the format variations, and wherein the combiner program is further arranged to convert the generated original digital content data into a data format specific to, and supported by, a playback device.

55. A method according to claim 54, wherein the combiner program is arranged to playback the original content data on a conventional personal computer without requiring storage of the content data on the personal computer.

56. A method of recording digital content data onto an AVDDM (Audio Visual Data Distributable Medium), the method comprising:
assigning a unique identifier to the AVDDM;
using the unique identifier to create a plurality of data errors in and/or format variations of the digital content data unique to that AVDDM;
encrypting the unique identifier; and
recording the digital content data incorporating the data errors and/or format variations and the encrypted unique identifier onto the AVDDM.

57. An AVDDM (Audio Visual Data Distributable Medium) comprising:
a unique identifier to the AVDDM;
digital content data incorporating a unique plurality of data errors and/or format variations which have been determined for the AVDDM from the unique identifier to the AVDDM, wherein the format variations include variations in spacing between items of content recorded on the AVDDM.

58. An AVDDM (Audio Visual Data Distributable Medium) comprising:
a unique identifier to the AVDDM;
digital content data incorporating a unique plurality of data errors and/or format variations which have been determined for the AVDDM from the unique identifier to the AVDDM, wherein the format variations include variations in the length of one or more digital data sessions of the content recorded on the AVDDM.

59. An AVDDM (Audio Visual Data Distributable Medium) comprising:
a unique identifier to the AVDDM;
digital content data incorporating a unique plurality of data errors and/or format variations which have been determined for the AVDDM from the unique identifier to the AVDDM, wherein the format variations include at least one data file additional to a digital data session of the content recorded on the AVDDM.

60. An AVDDM (Audio Visual Data Distributable Medium) comprising:
a unique identifier to the AVDDM;
digital content data incorporating a unique plurality of data errors and/or format variations which have been determined for the AVDDM from the unique identifier to the AVDDM;
a copyright protection map for identifying the unique plurality of data errors in and/or format variations of the digital content data; and
a combiner, the combiner being arranged, in use, to combine the copyright protection map with the digital content data incorporating the data errors and/or format variations to generate the original unprotected digital content data by removing the data errors and/or accommodating the format variations.

61. An AVDDM according to claim 60, wherein the copyright protection map is encrypted, and the combiner is arranged to transmit the unique identifier to a remote location over a telecommunications network and to receive a decryption key for decrypting the copyright protection map.
